(19) United States
(12) Patent Application Publication
(10) Pub. No.: US 2014/0109716 A1
(43) Pub. Date: Apr. 24, 2014

(54) BICYCLE CONTROL CABLE

(71) Applicant: SHIMANO INC., Osaka (JP)

(72) Inventor: Takamoto ASAKAWA, Osaka (JP)

(73) Assignee: SHIMANO INC., Osaka (JP)

(21) Appl. No.: 13/778,773

(22) Filed: Feb. 27, 2013

(30) Foreign Application Priority Data
Oct. 22, 2012 (CN) 201220540395.0

(51) Int. Cl. F16C 1/20

(52) U.S. Cl. CPC F16C 1/205
USPC 74/502.5

(57) ABSTRACT

A bicycle control cable includes a plurality of strands a forming a wire and an organic coating film. The wire has an outer periphery. The organic coating film is disposed on the outer periphery of the strands. The organic coating film has a graduated degree of polymerization that becomes higher as the coating film approaches the strands.

### CROSS-REFERENCE TO RELATED APPLICATIONS

This application claims priority under 35 U.S.C. §119 to Chinese Patent Application No. 201220540395.0, filed Oct. 22, 2012. The entire disclosure of Chinese Patent Application No. 201220540395.0 is hereby incorporated herein by reference.

### BACKGROUND

1. Field of the Invention

This invention generally relates to an inner wire of a bicycle control cable for driving a bicycle transmission, brake device, etc.

2. Background Information

For bicycles and other transportation machines, control cables are used in order to operate a transmission, brake device, etc. Typically a bicycle control cable has an inner wire that moves inside of an outer casing. In order to improve the operability for the user, the inner wire preferably has a lower sliding resistance within the outer casing.

### SUMMARY

Generally, the present disclosure is directed to a bicycle control cable. In one feature, the bicycle control cable has a low sliding resistance and can be manufactured at a lower cost.

In view of the state of the known technology, a first aspect of the present invention is to provide a bicycle control cable that basically comprises a plurality of strands a forming a wire having an outer periphery and an organic coating film that is disposed on the outer periphery of the strands. The organic coating film has a graduated degree of polymerization that becomes higher as the coating film approaches the strands.

A second aspect presented in this disclosure is to provide a bicycle control cable that basically comprises a plurality of strands a forming a wire having an outer periphery and an organic coating film that is disposed on the outer periphery of the strands, wherein the organic coating film is one of a dehydration condensation polymer and a polymer reaction that is disposed on the outer periphery of the strands as the strands are heated.

Due to the organic coating film of the bicycle control cable according to either the first or second aspects, the sliding resistance between the inner wire and the outer casing can be decreased. In addition, since the degree of polymerization of the organic coating film becomes higher as the coating film approaches the strand, the close contact property between the organic coating film and the strands is excellent.

A third aspect of the present invention is to provide a bicycle control cable that basically comprises a plurality of strands a forming a wire having an outer periphery and an organic coating film that is disposed on the outer periphery of the strands, wherein the organic coating film is electrodepositioned on the strands. As a result, compared with the conventional spraying operation for forming the coating film, the wasting of the paint (the electrodeposition paint) as a feed material of the organic coating film can be suppressed, so that the manufacturing cost can be decreased. In addition, an organic coating film with excellent close contact property along the shape of the outer surface of the strands can be formed.

Preferably, the bicycle control cables according to the first, second and third aspects, the organic coating film is made of polyurethane resin, epoxy resin or acrylic resin. As a result, compared with the fluororesin or other organic coating film, the organic coating film has a better close contact property and a lower manufacturing cost.

Preferably, the bicycle control cables according to the first, second and third aspects, further comprises a solid lubricant layer that is formed on the organic coating film. Also, preferably the solid lubricant includes silicone, PTFE grains or MoS₂ powder. As a result, by forming the solid lubricant layer on the organic coating film, the sliding resistance between the inner wire and the outer casing is decreased.

In the bicycle control cables according to the first, second and third aspects, the organic coating film has a film thickness in a range of 1 μm to 50 μm. More preferably, the film thickness of the organic coating film is 10 μm to 40 μm. In addition, in the bicycle control cables according to the first, second and third aspects, an outer casing overlies the wire, which is an inner wire. As a result of forming the organic coating film with the range of film thickness described above, an even film thickness for the organic coating film can be easily formed, and the sliding resistance between the inner wire and the outer casing can be decreased.

For the bicycle control cable presented in this disclosure, the close contact property between the strands and the organic coating film is excellent, and the bicycle control cable can be manufactured at a low cost.

### BRIEF DESCRIPTION OF THE DRAWINGS

Referring now to the attached drawings which form a part of original disclosure:

FIG. 1 is a side elevational view of a bicycle that that is equipped with a bicycle control cable in accordance with one illustrave embodiment;

FIG. 2 is an oblique view of a bicycle control cable according to the illustrated embodiment;

FIG. 3 is a schematic cross-sectional view of the inner cable of the bicycle control cable according to the illustrated embodiment; and

FIG. 4 is a flow chart illustrating a manufacturing process in forming an organic coating film in accordance with the illustrated embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

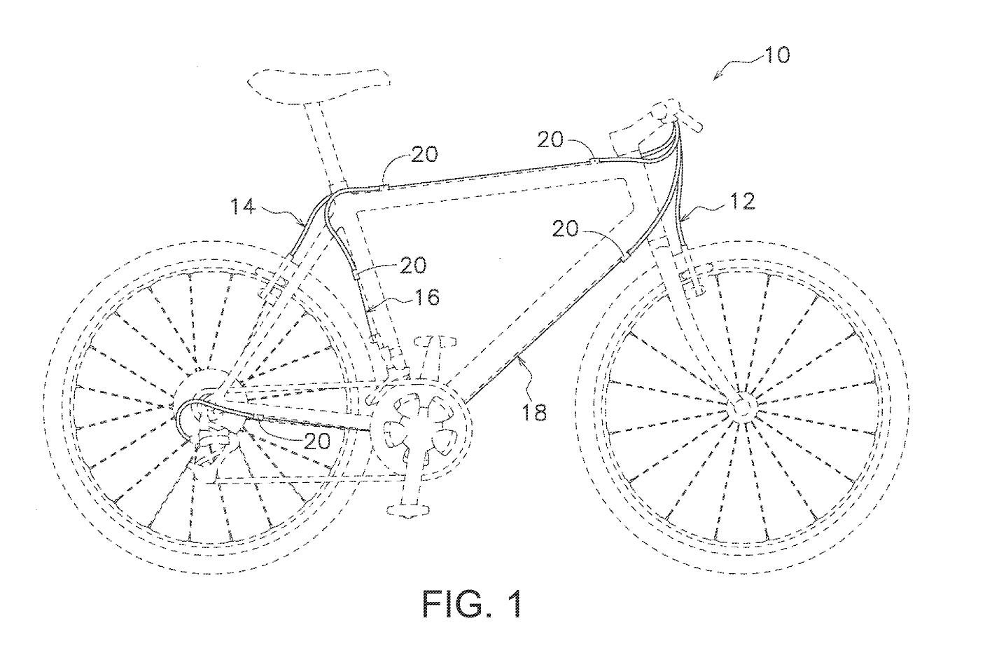

Referring initially to FIG. 1, a bicycle 10 is illustrated with a plurality bicycle control cables 12, 14, 16 and 18 according to one illustrated embodiment. The bicycle control cable 12 is operatively connected to a front brake lever and a front brake caliper. The bicycle control cable 14 is operatively connected to a rear brake lever and a rear brake caliper. The bicycle control cable 16 is operatively connected to a front shifter and a front derailleur. The bicycle control cable 18 is connected to the rear shifter and the rear derailleur. The bicycle control cables 12, 14, 16 and 18 are attached to the bicycle by a plurality of cable stops 20.

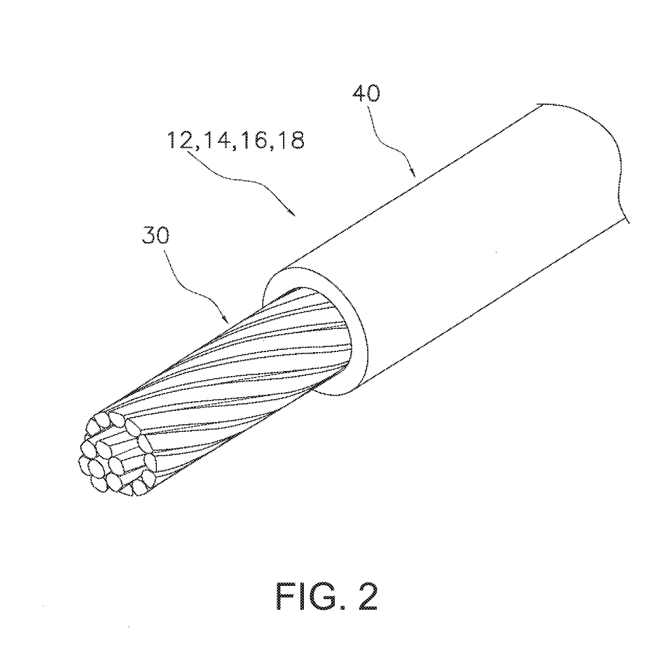

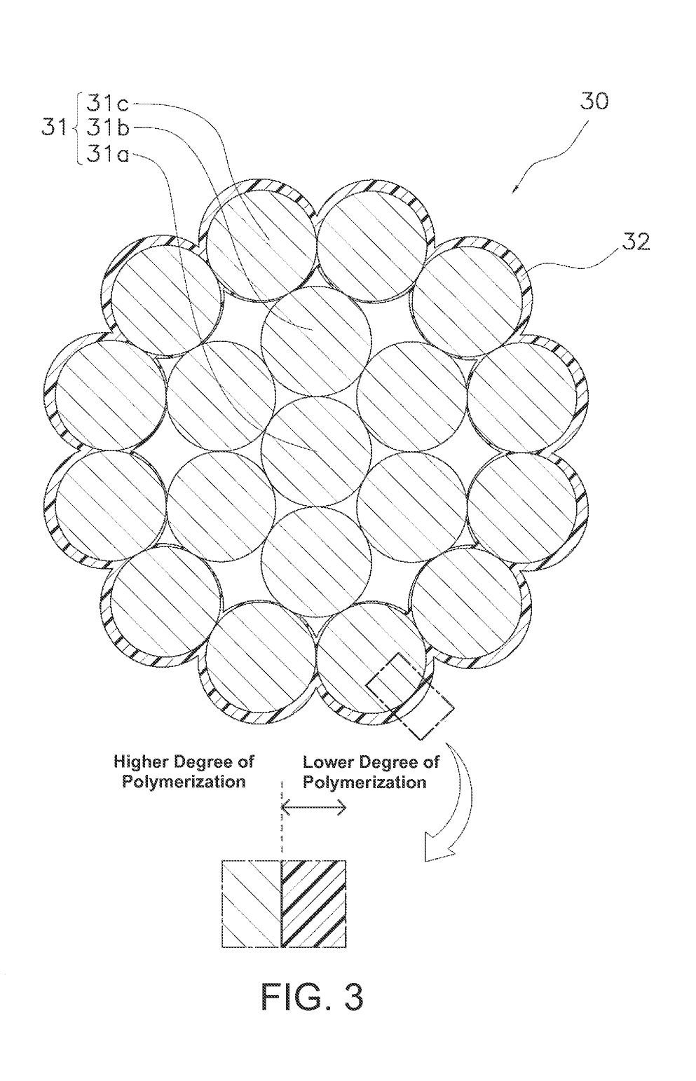

As shown in FIG. 2, each of the bicycle control cables 12, 14, 16 and 18 has an inner cable 30 and an outer casing 40. As shown in FIG. 3, the inner cable 30 includes a plurality of strand 31 made of a metal and an organic coating film 32 formed on the periphery of the strands 31. Alternatively, the inner cable 30 can be made of a single one of the strands 31. In FIG. 3, the thickness of the organic coating film 32 is shown in an exaggerated scale for illustration purposes, and the actual thickness is not shown. In this embodiment, the strands 31 are wires, which are made of iron. More specifically, the strands 31 are steel wires. In this embodiment, the strands 31 are classified into a first strand 31a, a plurality of second strands 31b and a plurality of third strands 31c. The first strand 31a is a single strand that is positioned at the center of the strands 31. There are six of the second strands 31b, which are arranged on the outer peripheral side of the first strand 31a. There are twelve of the third strands 31c, which are arranged on the outer peripheral side of the second strands 31b. Consequently, the inner cable 30 is made of a total of nineteen of the strands 31. In this embodiment, the first strands 31a, the second strands 31b and the third strands 31c are of the same specifications, size and material. The second strands 31b are twisted on the outer peripheral portion of the first strand 31a. The third strands 31c are twisted on the outer peripheral portion of the second strands 31b. Although not shown in the drawings, the strands 31 may be prepared by a plating treatment.

According to this embodiment, the organic coating film 32 is formed on the third strands 31c after the third strands 31c have been twisted on the second strands 31b. Consequently, according to this embodiment, the organic coating film 32 is not formed on the first strands 31a and the second strands 31b. The organic coating film 32 is preferably made of the cationic type polyurethane resin, the cationic type epoxy resin, or the anionic acrylic resin. The organic coating film 32 has a graduated degree of polymerization that increases as the organic coating film 32 approaches the strands 31. On the outer surface portion of the organic coating film 32 with a low degree of polymerization, a solid lubricant layer containing silicone, PTFE grains, or MoS₂ powder is preferably formed. Also, the solid lubricant containing PTFE grains, silicone, or MoS₂ powder may be dispersed in the organic coating film 32. Due to the solid lubricant, the sliding resistance between the inner cable 30 and the outer casing 40 can be decreased. The film thickness of the organic coating film 32 is preferably in the range of 1 μm to 50 μm or, more preferably, in the range of 10 μm to 40 μm. By forming the organic coating film with a film thickness in this range, an even film thickness of the organic coating film 32 can be easily formed on the strands 31, and the sliding resistance between the inner cable 30 and the outer casing 40 can be decreased.

As shown in FIG. 2, the outer casing 40 slidably accommodates the inner cable 30. The outer casing 40 is mainly formed from a synthetic resin. However, the outer casing 40 may also contain a reinforcing member knitted from steel wires and in a flexible cylindrical shape in the outer casing 40.

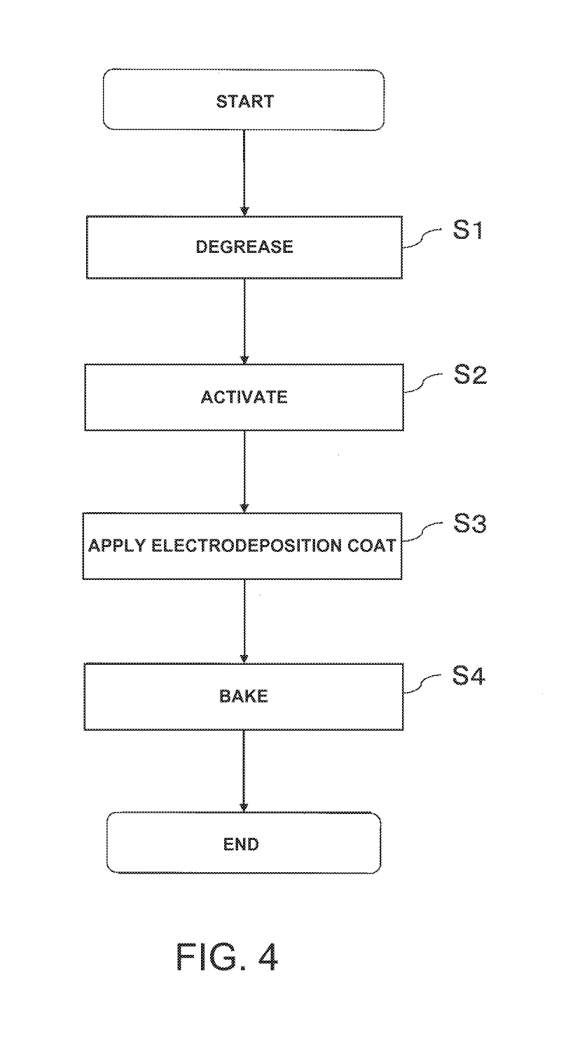

Manufacturing process of the organic coating film formation treatment according to the first embodiment will now be explained. In the following, an example of the manufacturing process of the formation treatment of the organic coating film 32 will be explained with reference to FIG. 4. Before the operation shown in FIG. 4, as needed, the strands 31 are subject to a plating treatment. Then, the second strands 31b are twisted on the peripheral portion of the first strands 31a, and the third strands 31c are twisted on the outer peripheral portion of the second strands 31b.

First of all, in step S1, a degreasing treatment is carried out for the strands 31. Then, in step S2, a surface treatment agent is used to activate the surface of the metal material of the strands 31. In step S3, the activated strands 31 are dipped in an electrodeposition liquid, such as cationic polyurethane resin, a cationic epoxy resin, or an anionic acrylic resin, for electrodeposition coating. By carrying out the organic coating film treatment with a high-precision film thickness control, such as the electrodeposition coating, the organic coating film 32 is formed, with the film thickness of the organic coating film 32 in the range of 1 μm to 50 μm or, preferably, in the range of 10 μm to 40 μm. Then, in step S4, as the strands 31 are heated, dehydration condensation or a polymerization reaction or other chemical reaction takes place. As a result, the organic coating film 32 is formed on the outer peripheral surface of the third strands 31c. Also, as the dehydration condensation or polymerization reaction makes progress from the surface of the strands 31 (the interior of the resin), the nearer the site is to the strands 31, the higher the degree of polymerization becomes. When the organic coating film 32 is formed on the strands 31 in this electrodeposition coating operation, as compared with the formation of the coating film by the conventional spraying operation, the wasting of the paint (electrodeposition paint) as the feed material of the organic coating film 32 can be suppressed, and the manufacturing costs can be lowered. In addition, a bicycle control cable with an excellent close contact property between the strands 31 and the organic coating film 32 can be provided.

Also, after the step S3, a solid lubricant is preferred to be coated on the organic coating film 32 in uncured state; or, after the step S4, a solid lubricant can be coated on the organic coating film 32.

In the following, the effects of the bicycle control cable according to this embodiment will be explained. For this bicycle control cable, due to the organic coating film 32, the sliding resistance between the inner wire and the outer casing can be decreased. In addition, as the degree of polymerization becomes higher as the site is nearer to the strand, the close contact property between the organic coating film and the strand is excellent. In addition, because the organic coating film is generated by the chemical reaction with the liquid made of the cationic epoxy resin or the anionic acrylic resin, the manufacturing cost becomes lower.

### Modification Examples

In the embodiment previously described, the first strand 31a to the third strands 31c have the same diameter. However, the first strand 31a to the third strands 31c may also have different diameters. For example, the first strands 31a at the center may have a diameter larger than the second strands 31b and the third strands 31c. In addition, the number of the strands 31 is not limited to the number previously described in the embodiment. Any number of one or larger is acceptable.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle control cable comprising:
a plurality of strands forming a wire having an outer periphery; and
an organic coating film disposed on the outer periphery of the strands, and the organic coating film having a graduated degree of polymerization that becomes higher as the organic coating film approaches the strands.

2. The bicycle control cable according to claim 1, wherein
the organic coating film is made of one of a polyurethane resin, an epoxy resin and an acrylic resin.

3. The bicycle control cable according to claim 1, further comprising
a solid lubricant layer formed on the organic coating film.

4. The bicycle control cable according to claim 3, wherein
the solid lubricant includes one of silicone, PTFE grains and MoS₂ powder.

5. The bicycle control cable according to claim 1, wherein the organic coating film has a film thickness in a range of 1 μm to 50 μm.

6. The bicycle control cable according to claim 1, wherein the organic coating film has a film thickness in a range of 10 μm to 40 μm.

7. The bicycle control cable according to claim 1, further comprising
an outer casing overlying the wire, which is an inner wire.

8. A bicycle control cable comprising:
a plurality of strands forming a wire having an outer periphery; and
an organic coating film disposed on the outer periphery of the strands, the organic coating film being one of a dehydration condensation polymer and a polymer reaction that is disposed on the outer periphery of the strands as the strands are heated.

9. The bicycle control cable according to claim 8, wherein
the organic coating film is made of one of a polyurethane resin, an epoxy resin and an acrylic resin.

10. The bicycle control cable according to claim 8, further comprising
a solid lubricant layer formed on the organic coating film.

11. The bicycle control cable according to claim 10, wherein
the solid lubricant includes one of silicone, PITT grains and MoS₂ powder.

12. The bicycle control cable according to claim 8, wherein
the organic coating film has a film thickness in a range of 1 μm to 50 μm.

13. The bicycle control cable according to claim 8, wherein
the organic coating film has a film thickness in a range of 10 μm to 40 μm.

14. The bicycle control cable according to claim 8, further comprising
an outer casing overlying the wire, which is an inner wire.

15. A bicycle control cable comprising:
a plurality of strands forming a wire having an outer periphery; and
an organic coating film electrodepositioned on the outer periphery of the strands.

16. The bicycle control cable according to claim 15, wherein
the organic coating film is made of one of a polyurethane resin, an epoxy resin and an acrylic resin.

17. The bicycle control cable according to claim 15, further comprising
a solid lubricant layer formed on the organic coating film.

18. The bicycle control cable according to claim 17, wherein
the solid lubricant includes one of silicone, PTFE grains and MoS₂ powder.

19. The bicycle control cable according to claim 15, wherein
the organic coating film has a film thickness in a range of 1 μm to 50 μm.

20. The bicycle control cable according to claim 15, wherein
the organic coating film has a film thickness in a range of 10 μm to 40 μm.

21. The bicycle control cable according to claim 15, further comprising
an outer casing overlying the wire, which is an inner wire.
